(19) United States
(12) Patent Application Publication
(10) Pub. No.: US 2008/0059652 A1
(43) Pub. Date: Mar. 6, 2008

(54) Routing for Detection of Servers Within a Communication Network

(75) Inventor: Christophe Preguica, Massy (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL, Paris (FR)

(21) Appl. No.: 11/569,797

(22) PCT Filed: May 31, 2005
(86) PCT No.: PCT/FR05/50396

§ 371 Date: Feb. 1, 2007

(30) Foreign Application Priority Data
Jun. 1, 2004 (FR) 0451077

(51) Int. Cl. G06F 15/173

(52) U.S. Cl. 709/242

(57) ABSTRACT

The invention relates to network equipment (R₂) comprising: means for communicating with neighbouring devices which are connected by means of communication networks; and routing means for transmitting routing information to said neighbouring devices (R₁, R₃), said information containing the address that is associated with each of the communication networks (n₁, n₂). The equipment is characterized in that the routing means can add an indicator to the routing information, which indicates the presence of a server (S₁, S₂) that is connected to one of the communication networks and which is associated with the address of the communication network.

This invention relates to communication networks, in particular those based on a protocol stack of the IP (Internet Protocol) type. It relates more precisely to the routing within such networks.

Routing is the process by which network equipment communicates information to its neighbours, in order that each of them might have a sufficiently complete view of the network to be able to route correctly the packets to be transmitted to the communication network.

This so-called “routing” data is transmitted according to routing protocols. These routing protocols are, for example, OSPF (Open Shortest Path First), BGP (Border Gateway Protocol), etc. for fixed networks, or TBRPF (Topology Dissemination Based on Reversed-Path Forwarding) or OLSR (Optimized Link-State Routing), in the “ad hoc” mobile networks field or MANET (Mobile Ad-hoc NETwork).

These protocols are defined by documents issued by the IETF (Internet Engineering Task Force).

Communication networks can also include various types of server. These may be DNS (Domain Name System) servers as defined by the IETF's RFCs 1034 and 1035, DHCP (Dynamic Host Configuration Protocol) servers, as defined by RFCs 2131 and 2132, and LDAP (Lightweight Directory Access Protocol) servers.

Server addresses are usually configured manually on each of the network systems in order that the latter have access to their services. These services may also be accessible via a global address (so-called “multicost”) known to each of the network systems can allowing them to access the server's services.

However, this is not an ideal arrangement, as there may be several servers implementing the same services in a single network.

In such a situation, as the various servers share the same global address, all will be contacted.

It may therefore be possible that a large number, maybe all, respond to the same request, thus overloading the network to no avail, at the same time wasting bandwidth.

Moreover, this solution needs to register “multicast” address with an organization centralizing the allocation of such addresses currently the IANA (Internet Assigned Numbers Authority).

Similarly, this solution involves network architecture restrictions, in particular to define what the scope of the query must be. Whatever this may be, the network becomes difficult to administer.

In addition, there is nothing that allows a system to contact the closest server 15 supplying the required service. To log on to a server which is not the closest is not ideal, as it increases the call time and causes congestion of the network.

The aim of the invention is to alleviate these disadvantages, while proposing a network equipment having means of communication with adjoining systems connected by communication networks, and means of routing to transmit this routing data to these adjoining systems. The routing data contains the address corresponding to each of the communication networks. This equipment is characterised in that its routing means are capable of adding into the routing data an indicator of the presence of a server connected to one of the communication networks, corresponding to the address of this communication network.

According to one embodiment, the means of routing insert presence indicators at a position corresponding to the type of server.

According to one embodiment, the means of routing insert said indicators as binary indicators or flags.

According to one implementation of the invention, the types of server are included in a list incorporating a DNS server, a DHCP server and a LDAP server. The object of the invention is also a method implementing such network systems, i.e. more precisely, a method for transmitting the address of a server (DNS, DHCP, LDAP or other) within a grouping of network systems. This method incorporates the transmission of routing data from each of the network systems to adjoining systems connected by the communication networks, this routing data containing the address corresponding to each of the communication networks.

This method is characterised by the server being connected to a communication network, itself connected to given network equipment and by this network equipment inserting into the routing data an indicator of the presence of the server in question corresponding to the address of the communication network.

Finally, one objective of the invention is also a computer program implementing the process above in a distributed manner over this grouping of network systems.

Therefore each network system knows where the servers are as well as their addresses. It can therefore contact each of them individually, without calling on a global address as in the current state of the art. This method eliminates the situation where several servers respond to the same request.

The invention and its advantages will become clearer in the description which will follow in connection with the appended figures.

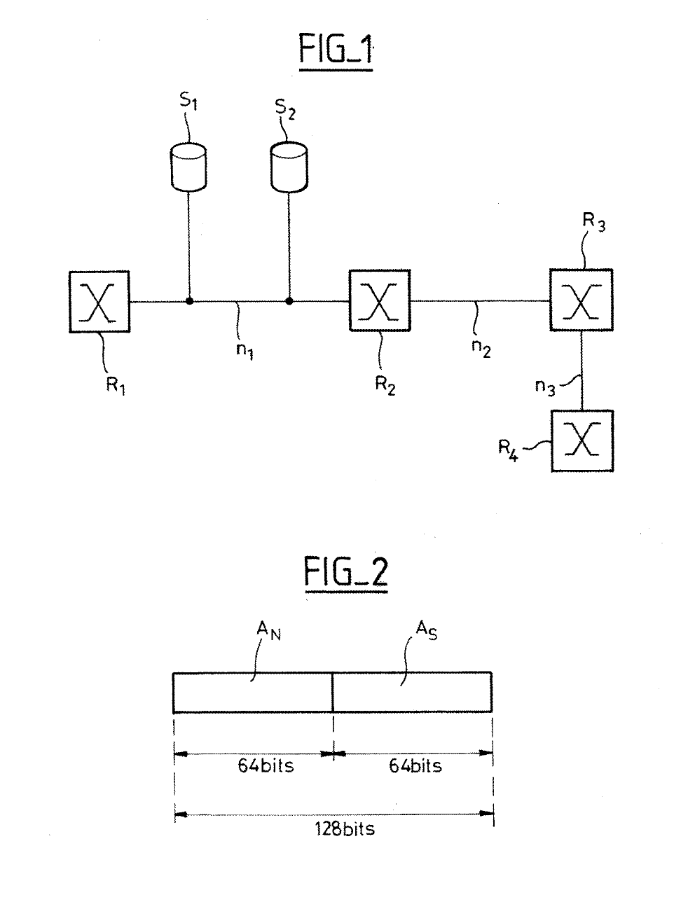

FIG. 1 represents a set of connected networks incorporating two servers.

FIG. 2 illustrates how to construct a server address.

The architecture represented by FIG. 1 incorporates 4 systems or routers R₁, R₂, R₃ R₄ interconnected by 3 networks n₁, n₂, n₃. Two servers S₁ and S₂ are also connected to the network n₁.

Conventionally, a routing protocol implemented over this architecture can convey network addresses n₁ n₂ and n₃ through the architecture such that each system recognizes it.

These addresses are transmitted by means of routing data.

According to the invention, the means of routing of each router connected to a network incorporating at least one server adds into the routing data.

One or more indicators of the presence of this or these servers. This or these indicators correspond to the corresponding network addresses. Thus the equipment R₂ transmits routing data containing one or more indicators of the presence of the servers S₁ and S₂ corresponding to the network n₂. According to one implementation, the network equipment transmits a routing message containing several fields, including at least one field containing the address of the link, a field containing a metric corresponding to this link and a server presence field.

According to one embodiment, the means of routing insert presence indicators at a position corresponding to the type of server.

These indicators may for example be binary indicators (flag) indicating the presence (for example “1”) or absence (for example “0”) of a server of a given on this network.

For example, the network data for the network n may have the following form:

| | | | |
|---|---|---|---|
| 0...0 | 1 | 1 | 0 |

The first “1” can indicate the presence of a server of the “DNS” type (for example S₁), the second “1” the presence of a server of the “DHCP” type (for example S₂) and the third bit set to “0” indicates the absence of a third type of server.

Accordingly, one type of server corresponds to a position.

Thus, any equipment from the architecture can receive, at the same time as the routing data, indicators of the presence or absence of servers. It is therefore possible to determine where the servers of a given type are.

According to another embodiment, a value corresponds to each type of server. For example, the value 1 corresponds to the “DNS” type, the value 2 (“10″ in binary”) corresponds to the “DHCP” type and the value 9 (“1001” in binary) corresponds to the presence of servers of the “DNS” and “DHCP” types, etc.

The choice of embodiment can depend on the number of servers. As cited previously, according to some routing protocols, a metric corresponds to each network address transported in the routing data. This metric lets us establish the size of a network according to a certain criterion, for example the minimum number of systems linking the equipment and the network (“hop”).

This metric can be used by the equipment to determine the closest server offering the required service. For a given service, the equipment can look up its routing table, wherein are stored routing data received previously and determine all the addresses corresponding to a presence indicator for a given type of server. The equipment can then determine which address from this set corresponds to the lowest metric and send a service request to the latter.

FIG. 2 illustrates how to construct the server address in the case of an architecture of the type IPv6 (Internet Protocol version 6). This breaks down into two parts:
the address of the network Aₙ
a server identifier Aₛ.

The network address is that provided by the routing data (and which can be found by each piece of equipment in its routing table). The server identifier Aₛ is a predefined value corresponding to the type of server.

Both these parts may each be 64 bits in length and together form a 128-bits address of the “Anycast” type.

Each piece of equipment can thus easily reconstruct the “anycast” address of the closest server offering the required service.

Under the OSPF v3 protocol, the server presence indicators are included in the “Prefix Option” field of the LSA (Link Status Advertisement). This 8-bit field in fact contains 4 bits whose use is left free by the IETF's RFC 2740.

In one implementation of the invention using the BGP protocol, the server presence indicators are included in the “Attribute Flags” field of the “Path Attribute” attribute.

In one implementation of the invention using the TBRPF protocol, the server presence indicators are included in the “Reserved” field of the “Network Prefix Association” field.

Preferably, if a system triggers a route aggregation action in its routing table, it must ensure that the server presence indications remain compliant with reality. In order to do this, it can
maintain a non-aggregated route corresponding to the network containing one server.
Aggregate routes, while deleting server presence indicators.

1. Network equipment (R₂) having means of communication with adjoining systems connected by communication networks, and means of routing in order to transmit routing data to said adjoining systems (R₁, R₃), the address corresponding to each of said communication networks (n₁, n₂), characterised in that said means of routing are capable of adding into said routing data a server presence indicator (S₁, S₃) connected to one of said communication networks, corresponding to the address of said communication network.

2. Equipment according to claim 1, wherein said means of routing insert said presence indicators at a position corresponding to the type of said server.

3. Equipment according to the claim 1, wherein said means of routing insert said indicators as binary indicators or flags.

4. Equipment according to claim 1, wherein said types of server are included in a list incorporating a DNS server, a DHCP server and a LDAP server.

5. Method for transmitting the address of server within a grouping of network systems, incorporating the transmission of routing data from each of said network systems to the adjoining systems connected by the communication networks, said routing data containing the address corresponding to each of said communication networks, characterised by said server being connected to a communication network, itself connected to a given network system, and by said network system inserting in said routing data an indication of the presence of said server, corresponding to the address of said communication network.

6. Computer program implementing the method according to claim 5, distributed over said grouping of systems.
